(19) United States
(12) Patent Application Publication
(10) Pub. No.: US 2011/0059424 A1
(43) Pub. Date: Mar. 10, 2011

(54) Visual Mathematical Learning Device

(76) Inventor: Don Bernard Wijesiriwardena, Downey, CA (US)

(21) Appl. No.: 11/853,637

(22) Filed: Sep. 11, 2007

(51) Int. Cl. G09B 23/02

(52) U.S. Cl. 434/200; 434/191

(57) ABSTRACT

A visual mathematical learning aid of numbers and their increasing values as they increase from left to right and from bottom to upward direction through the use of a container with lid for vertically maintaining a plurality of calibrated rods representing the units 1-10 in ascending order from right to left.

### BACKGROUND OF THE INVENTION

### Field of the Invention

The present invention relates generally to educational aid and, more specifically, to visual mathematical learning device.

The present invention is a visual mathematical learning device for children having a container and lid containing ten bi-color banded rods of lengths to represent place values of numbers. The user stands the bi-color banded rods vertically by inserting said rods into the recesses provided in the lid and base block at the bottom of the container. Numeric tiles are also provided and are placed relevant to the rod placement.

One objective of the learning device is a visual mathematical learning aid of numbers and increasing values as they increase from left to right and from bottom to upward direction. Steps for the present invention's visual mathematical learning of numbers and increasing values include:

a) Remove calibrated rods and alphanumeric tiles from base container and replace lid;

b) Identify shortest rod and place in aperture furthest to the left so that the rod stands vertically;

c) Count the number of color bands on the rod previously placed;

d) Identify alphanumeric tile that coincides with the number of bands on the rod;

e) Place numeric tile adjacent to rod that coincides with that number of bands;

f) Identify rod next in length and place in lid aperture to the right of previously placed rod; and

g) Repeat (steps c-f) until all rods of increasing length are placed into base apertures and coinciding alphanumeric disc is placed adjacent to said rods.

Upon completion the user is provided visual aid that supports numbers have values and they increase from left to right and from bottom to upward direction. Selecting any two numbers from one to ten, the number on the left is less (shorter) than the one on the right. Similarly the number on the right is taller, greater and more than any number to the left of that number.

Addition

Select any two numbers, example 9 and 6. Select the larger number of the two (one to the right), which is 9 and now start counting the calibrations on the rod marked six. (nine), identifying the number nine rod, start counting the calibrations on number 6 rod; ten, eleven, twelve, thirteen, fourteen, fifteen, 9+6=15. This develops in the child to do logical thinking of adding the smaller number to the bigger number. Another example: 5+7, Select the bigger number (7) and start adding the calibrations of number five rod. It is better for the child to start counting the smaller number from bottom to top. The principal of value increase to the right and in the upper direction is basic algebra that is introduced to a child at a very tender age.

Another objective is a visual mathematical learning aid for simple addition of numbers. Since the rods are banded with 2 colors, the user can calculate the sum of two addends by counting the number of bands of each color. Ex. Rod with 4 red bands and 3 blue bands, 7 bands total (4+3=7).

### DESCRIPTION OF THE PRIOR ART

There are other educational devices designed for mathematical instruction. Typical of these is U.S. Pat. No. 1,183,570 issued to Kneeshaw on May 16, 1916.

Another patent was issued to Trapnell on Jan. 10, 1950 as U.S. Pat. No. 2,494,497. Yet another U.S. Pat. No. 2,899,757 was issued to Webb on Aug. 18, 1959 and still yet another was issued on Aug. 30, 1960 to Steelman as U.S. Pat. No. 2,950,542.

Another patent was issued to Pollock on Sep. 7, 1965 as U.S. Pat. No. 3,204,343. Yet another U.S. Pat. No. 4,518,359 was issued to Yao-psong on May 21, 1985. Another was issued to Tan on Apr. 27, 1993 as U.S. Pat. No. 5,205,747 and still yet another was issued on Mar. 29, 1994 to Manancero as U.S. Pat. No. 5,297,965.

Another patent was issued to Huang on May 2, 2000 as U.S. Pat. No. 6,056,553. Yet another U.S. Pat. No. 7,059,861 was issued to Baumgartner on Jun. 13, 2006.

### U.S. Pat. No. 1,183,570

### Inventor: John Kneeshaw

### Issued: May 16, 1916

An educational appliance comprising a frame with top and bottom front strips forming each a groove with the frame, means in the top surface of the frame adapted to secure a like appliance, and a plurality of symbol plates adapted to be inserted into and removed from the appliance.

### U.S. Pat. No. 2,494,497

### Inventor: Buel L. Trapnell

### Issued: Jan. 10, 1950

An educational device comprising at least one block of unit length and a plurality of blocks of diverse lengths but each having a length which is a multiple of said unit length, each of said blocks having a bore extending lengthwise therethrough for positioning said blocks upon the below-mentioned posts, a key block having indicia thereon of the mathematical operation to be performed, said key block having two parallel bores extending therethrough for positioning said key block upon said below-mentioned posts; and two juxtapositioned posts for said blocks, said key block being adapted to be held jointly by both of said posts one of said posts receiving a block of multiple unit length and positioned upon said key block as indicated by said key block, the other post receiving a plurality of blocks each of lesser unit length but in total equal to said block of multiple unit length, said blocks of lesser unit length also being positioned upon said key block as indicated thereby whereby the said blocks illustrate concretely a mathematical problem and its solution.

### U.S. Pat. No. 2,899,757

### Inventor: Goebel W. Webb

### Issued: Aug. 18, 1959

In a device for teaching arithmetic, a base of rectangular configuration, a vertical column of rectangular configuration rigidly secured adjacent one end of said base and upon the upper surface thereof, said column divided into a plurality of identical sections by circumferentially extending lines which are longitudinally equally spaced apart and in planes parallel with said upper surface of said base, a circular rod rigidly secured upon said base in parallel spaced apart relation from and with said vertical column, and a number of rectangular blocks, said blocks provided with longitudinal bores centrally located therethrough for positioning same upon said circular rod and adjacent said vertical column, said sections on said column are marked to represent a series of denominations, a number is positioned in each section to represent a particular denomination, said blocks being numbered and of lengths corresponding to integral multiples of said sections on said column and a number corresponding to the number of the block, whereby when said blocks are arranged on said circular rod adjacent said vertical column, the total height of the column of blocks being indicated by the number on said vertical column and the circumferential line thereon adjacent the upper end of said column of blocks.

### U.S. Pat. No. 2,950,542

### Inventor: Alice M. Steelman

### Issued: Aug. 30, 1960

A visual aid for teaching addition, subtraction, and other simple arithmetical facts, comprising a set of ten thin flat strips of progressively varying lengths, each strip being blank on one face and bearing indicia on the other face, said indicia comprising a numeral, such as 1, 2, etc., up to 10, on one end of each strip and a number of spots spaced uniformly along the remainder of the strip, longitudinally thereof, the number of spots on each strip being the same as the numeral on the strip, the numeral on each strip occupying approximately one unit of length of the strip and each of said spots occupying approximately another unit of length, so that the total length of each strip is equal in said units to the numeral plus one, the spacing of the spot or spots and the numeral on each strip being such that when two or more of the smaller number strips are arranged in end to end relation with the lower end of one strip overlying the numeral on the next lower strip the spots on both strips are spaced apart uniformly so that a larger number strip which includes the number of spots that constitutes the sum of the spots of the two or more smaller number strips, maybe disposed alongside the end to end related strips and the spots of the larger number strip will be in lateral alignment with the spots on the smaller number strips.

### U.S. Pat. No. 3,204,343

### Inventor: Algernon Frederick Seton Pollock

### Issued: Sep. 7, 1965

In an apparatus for teaching or studying mathematics comprising a set of elements including a basic element which is substantially white in relation to the colors of the other elements of the set and which is a cube and a number of further elements increasing in length up to at least ten times the length L of an edge of said cube, said elements being identified as 2L, 3L, 4L, 5L, up to 10L, the improvement comprising: (1) the elements 2L, 3L, and 5L each being of a different primary pigment color, (2) the elements 2L, 4L and 8L being of the same primary color but in different intensities of that color obtained by increasing the pigment content in relation to the basic white in 4L with reference to 2L and 8L with reference to 4L, (3) the elements 3L and 9L being of the same primary color but in different intensities of that color obtained by increasing the pigment content in relation to the basic white in 9L with reference to 3L, (4) the element 6L being a composite color of the primary colors of the elements 2L and 3L, (5) the element 10L being a composite color of the elements 2L and 5L, (6) the element 7L being substantially gray and devoid of discernible color association with any of the said primary colors and related to the basic element by its white content.

### U.S. Pat. No. 4,518,359

### Inventor: Wang Yao-Psong

### Issued: May 21, 1985

A multi-purpose-instructing block comprising one hundred blocks divided into ten sets and a calculating frame having two grooves which are designed so that the blocks therein may be moved along the grooves. The blocks of the same set are of a size and color but the blocks of different sets differ in color and length. The multi-purpose instructing block is useful to interest the children in calculating, distinguishing between colors, learning alphabets in addition to making toy houses.

### U.S. Pat. No. 5,205,747

### Inventor: Daravuth Tan

### Issued: Apr. 27, 1993

An educational toy useable to teach elementary mathematics to children includes a spaced series of mutually aligned parallel rods secured in a side-by-side relationship at their opposite ends to a base portion of the toy. Series of counting beads are captively and slidably mounted on all but two of the rods for movement between their opposite end portions. The remaining two rods, each of which has at least one counting bead rod on each of its opposite sides, slidably carry two operational sign beads having convex polygonal cross-sections. Different equation operation sign indicia are suitably positioned on the flat exterior side surfaces of the sign beads such that they can be rotated about their rods to display selected operational signs to the user of the toy. Opposite end faces on each of the sign beads are recessed to nonrotatably receive projecting boss portions of the base at the opposite ends of the sign bead rods, thereby permitting the sign beads to be releasably locked against rotation away from their selected sign display orientations. By sliding the two sign beads and appropriate groups of the counting beads onto the same end portions of their associated rods, and rotatably adjusting the sign beads, a variety of simple mathematical equations can quickly and easily be represented by the beads in a form easily understood by a child.

### U.S. Pat. No. 5,297,965

### Inventor: Sergio O. Manancero

### Issued: Mar. 29, 1994

A mathematical and spatial toy apparatus is arranged to include a grooved rack board arranged to receive individual block components to teach children the mathematical cumulative effect of such boards to provide rudimentary teaching in mathematical and spatial relationships.

### U.S. Pat. No. 6,056,553

### Inventor: Pingsheng Huang

### Issued: May 2, 2000

A math playing and training system is disclosed. The system comprises two sets of playing pieces, each having a pair of numbers on both sides. The first set has ten pairs of numbers with each pair having a number on the back one number less than that on the front. Besides one pair of symbols of “+” and “−”, the second set has 9 pairs of numbers with each having two numbers equal to a sum of 10. For these 9 pairs of tiles there is a symbol of “−” on the front and “+” on the back. A turnover of two tiles at the same time gives players a direct result for addition or subtraction, and a better understanding of regrouping and pair concepts. The system employs the playing pieces and the pair concepts for playing and training in a vertical math operations especially in the fields of addition and subtraction. The system helps math beginners to master basic concepts of addition and subtraction and to reach the stage of mental arithmetic through entertaining playing and systematic training.

### U.S. Pat. No. 7,059,861

### Inventor: Margaret E. Baumgartner

### Issued: Jun. 13, 2006

The present invention relates to a math manipulative educational learning game in which a plurality of rods are provided for use in various manipulative games designed to teach rudimentary arithmetic skills. In the preferred embodiment, the rods are of various lengths and/or volumes, with the shortest length comprising a unit length, and other rods being formed in integral multiples of the unit length. Various games are disclosed in which a child is encouraged to manipulate the rods in various ways and in order to learn various arithmetic lessons. For example, in one game a Game Master selects any of the rods except the rod having unit length and places it upon a game playing surface. Thereafter, the Partner must select a plurality of rods whose combined lengths equal the length of the rod played by the Game Master. These rods are laid end-to-end along side the rod played by the Game Master in order to demonstrate their length equality. The Game Master then selects another rod other than the rod of unit length and lays the second rod end-to-end with the first rod which the Game Master played. The Partner is again required to select a plurality of rods to whose combined lengths, when placed end-to-end with the rods already played by the Partner, equal the length of the rods played by the Game Master. The play continues in this manner until no more moves may be made from the selection of rods remaining. Other manipulative games are also disclosed.

While these educational apparatus may be suitable for the purposes for which they were designed, they would not be as suitable for the purposes of the present invention, as hereinafter described.

### SUMMARY OF THE PRESENT INVENTION

A primary object of the present invention is to provide a visual mathematical learning device for children.

Another object of the present invention is to provide a visual mathematical learning device for children having a container and lid containing ten bi-color banded rods.

Yet another object of the present invention is to provide a visual mathematical learning device for children having 10 numerically numbered tablets.

Still yet another object of the present invention is to provide a visual mathematical learning device whereas the bi-color banded rods are vertically inserted into the recesses provided in the lid of the base block.

Another object of the present invention is to provide a visual mathematical learning device that aids the learning of numbers and increasing values as they increase from left to right.

A further object of the present invention is to provide a visual mathematical learning device that aids the learning of numbers and increasing values as they go from bottom to upward direction.

Yet another object of the present invention is to provide a visual mathematical learning device that aids the learning of simple addition of numbers.

Still yet another object of the present invention is to provide a visual mathematical learning device that is cost effective to manufacture and for the consumer.

Additional objects of the present invention will appear as the description proceeds.

The present invention overcomes the shortcomings of the prior art by providing a visual mathematical learning aid of numbers and their increasing values as they increase from left to right and from bottom to upward direction.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention in use;

FIG. 2 is a block diagram of the present invention's objectives;

FIG. 3 is a block diagram of the present invention's steps for learning of numbers and increasing values;

FIG. 4 is a block diagram of the present invention's steps for learning of simple addition of numbers;

FIG. 5 is a perspective view of the container of the present invention;

FIG. 6 is an exploded view of the container of the present invention;

FIG. 7 is an exploded view of the container of the present invention;

FIG. 8 is an exploded perspective view of the present invention;

FIG. 9 is a perspective view of the present invention;

FIG. 10 is a side exploded view of the present invention;

FIG. 11 is a top view of the lid of the present invention;

FIG. 12 is a bottom view of the lid of the present invention;

FIG. 13 is a top view of the bottom of the present invention; and

FIG. 14 is a sectional view of the bottom of the container of the present invention as cut from FIG. 10.

### DESCRIPTION OF THE REFERENCED NUMERALS

Turning now descriptively to the drawings, in which similar reference characters denote similar elements throughout the several views, the figures illustrate the Visual Mathematic Learning Aid for Children of the present invention. With regard to the reference numerals used, the following numbering is used throughout the various drawing figures.
10 Visual Mathematic Learning Aid for of the present invention
12 rectangular container
14 lid for 12
16 calibrated rod
18 numeric tile
20 user
22 lid recess
24 base block
26 first color band
28 second color band
30 base of 16

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

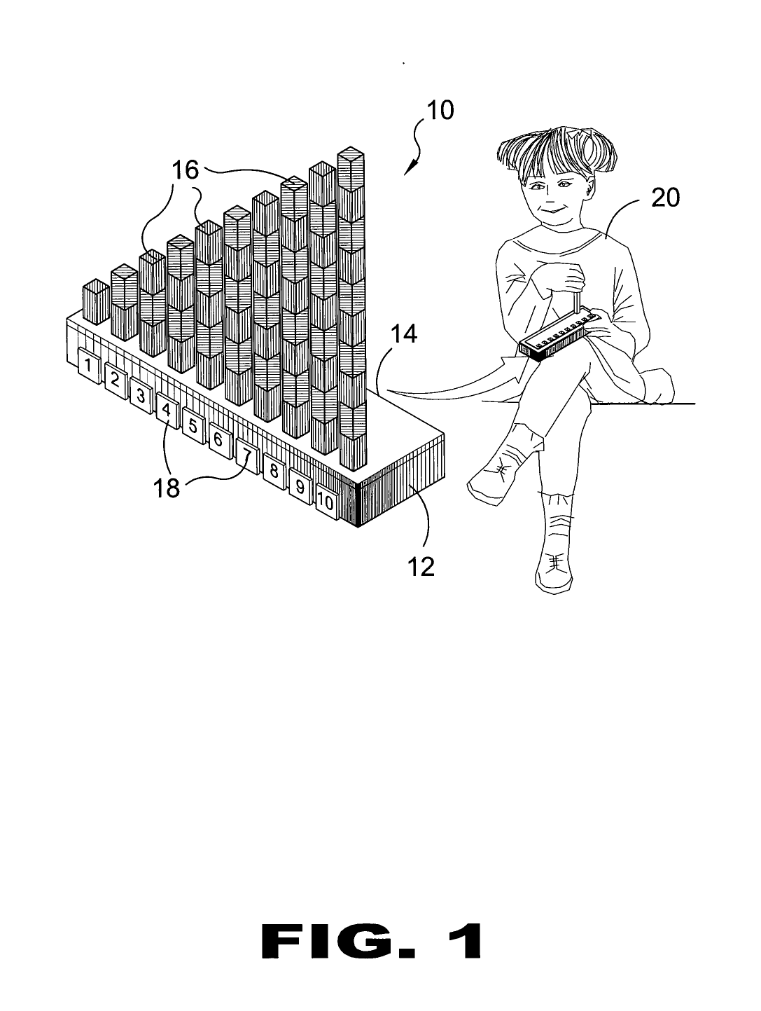

FIG. 1 is an illustrative view of the present invention 10 in use. The present invention is a mathematical learning device 10 for children having a container 12 and lid 14 containing ten calibrated rods 16 of lengths to represent place values of numbers that the user 20 stands vertically by inserting said rods 16 into the recesses 22 provided in the lid and base block at the bottom of the container. Numerical tiles are also provided and are placed relevant to the rod placement. The device aims at teaching children mathematics.

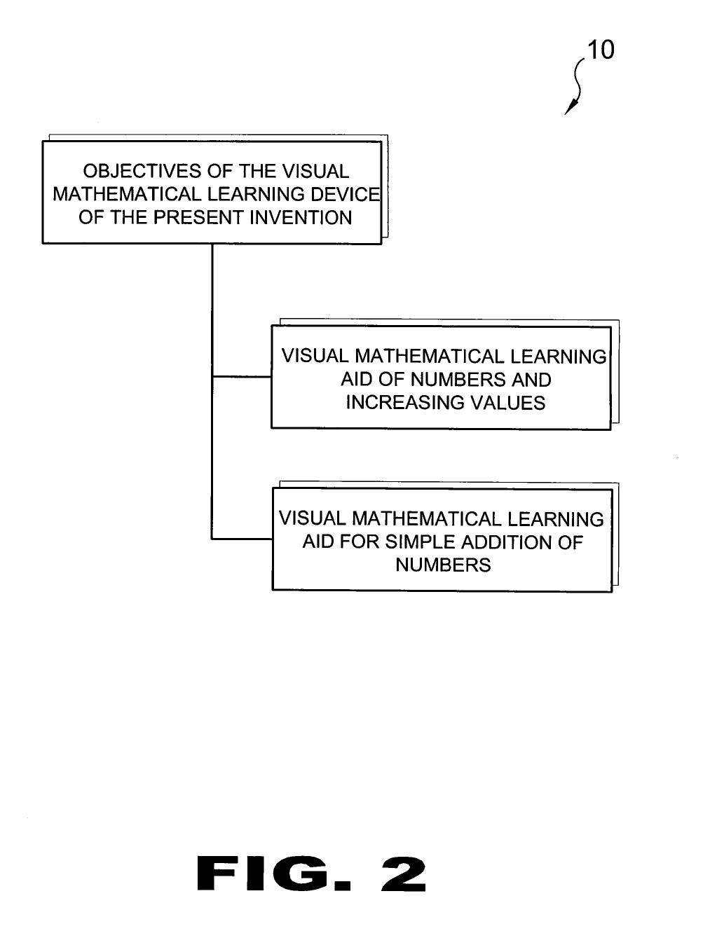

FIG. 2 is a block diagram of the present invention's 10 objectives. The objectives of the mathematical learning device 10 are to provide a visual mathematic learning aid of numbers and increasing values and also to provide a visual mathematic learning aid for simple arithmetic.

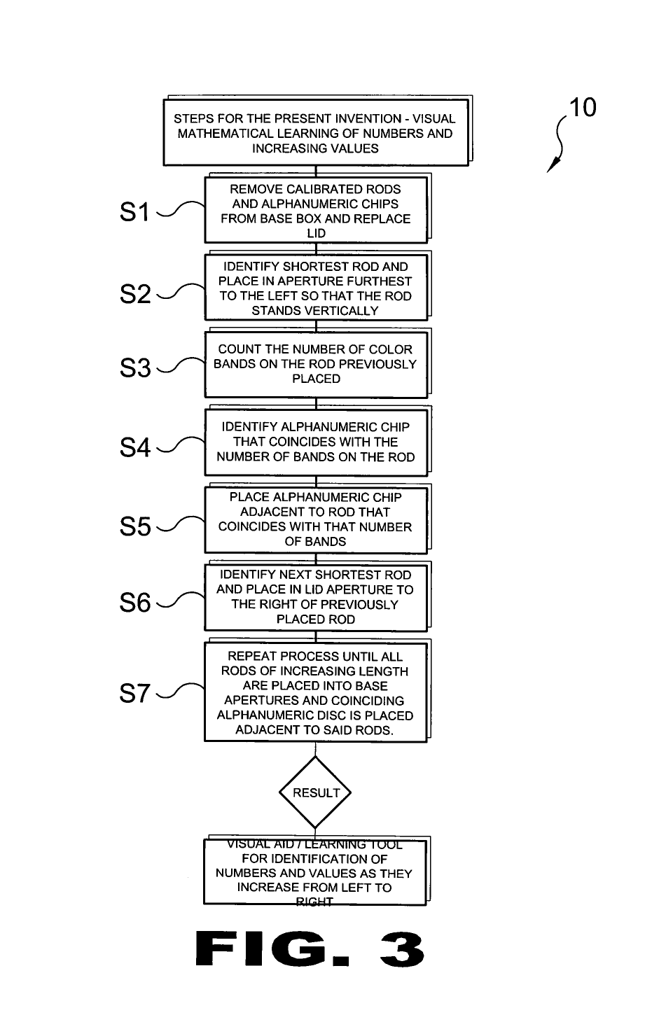

FIG. 3 is a block diagram of the present invention's 10 steps for learning of numbers and increasing values. The mathematical learning device for children 10 has a container and lid containing ten calibrated rods of lengths to represent place values of numbers and numeric tiles. Above depicts the steps required for the learning of numbers and increasing values in two directions, left to right and bottom to top.

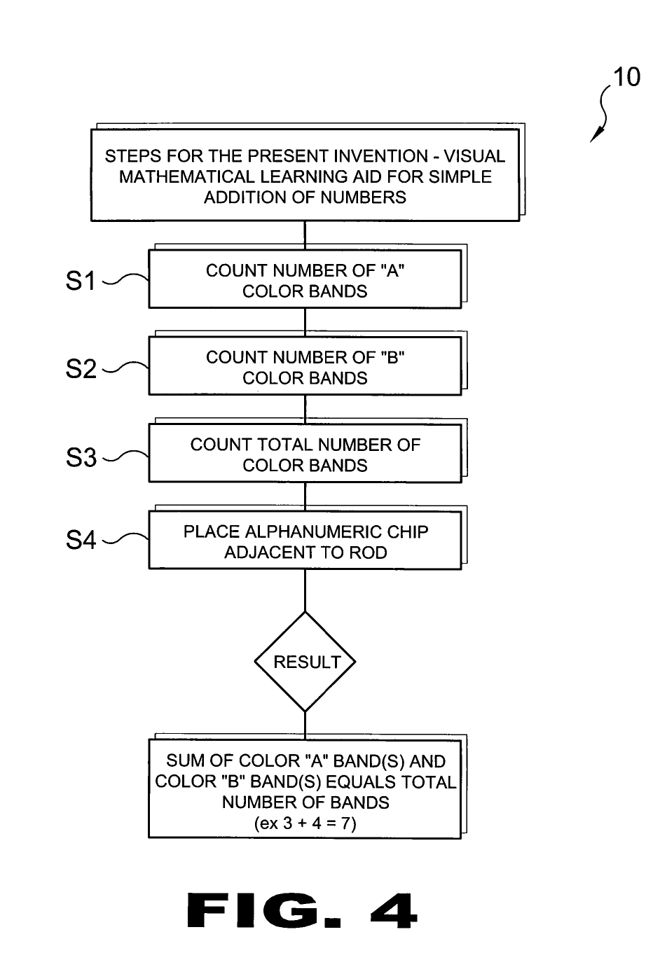

FIG. 4 is a block diagram of the present invention's 10 steps for learning of simple addition of numbers. Above depicts the steps required for learning of simple addition of number. Select any two numbers, example 9 and 6. Select the larger number of the two (one to the right), which is 9 and now start counting the calibrations on the rod marked six. (nine), identifying the number nine rod, start counting the calibrations on number 6 rod; ten, eleven, twelve, thirteen, fourteen, fifteen: 9+6=15. This develops in the child to do logical thinking of adding the smaller number to the bigger number. Another example: 5+7, select the bigger number (7) and start adding the calibrations of number five rod. It is better for the child to start counting the smaller number from bottom to top. The principal of value increase to the right and in the upper direction is basic algebra that is introduced to a child at a very tender age.

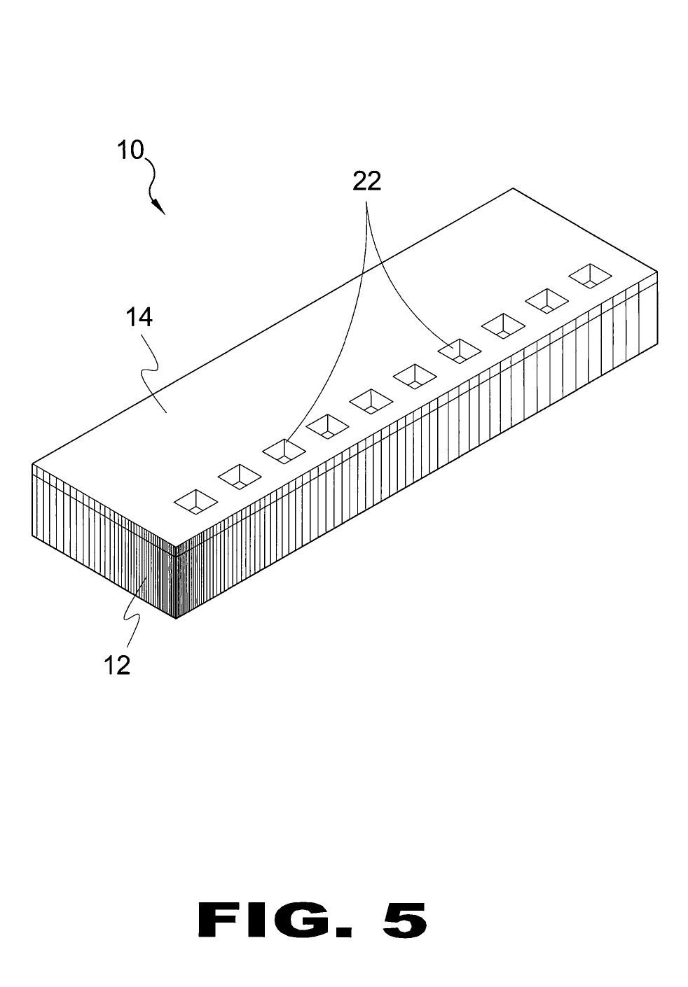

FIG. 5 is a perspective view of the container of the present invention 10. Shown is the container 12 for storing the rods and supporting the lid 14 with the lid 14 in the closed position. The lid 14 has ten linear recesses 22 disposed therein for passing the rods therethrough into the corresponding base blocks disposed in the bottom of the container 12.

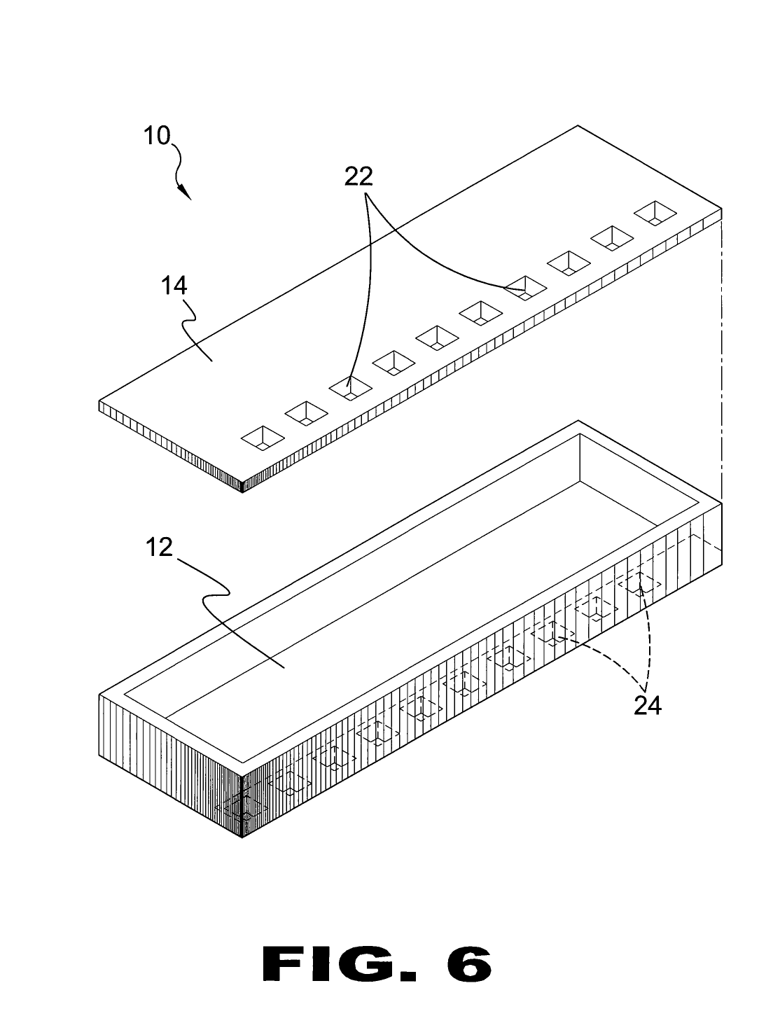

FIG. 6 is an exploded view of the container of the present invention 10. Shown is the container 12 with the lid 14 in the open position. The lid 14 has ten linear recesses 22 disposed therein for passing the rods therethrough into the corresponding base blocks 24 disposed in the bottom of the container 12.

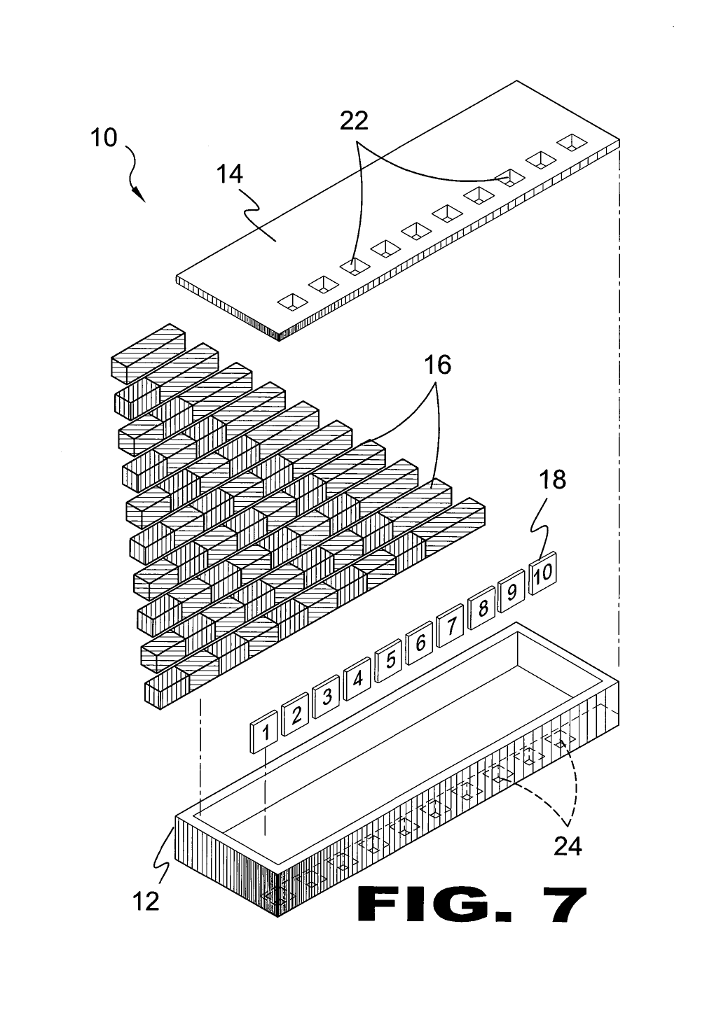

FIG. 7 is an exploded view of the container of the present invention 10. Shown is the container 12 with the lid 14 in the open position and the rods 16 and numeric tiles 18 removed therefrom. The lid 14 has ten linear recesses 22 disposed therein for passing the rods 16 therethrough into the corresponding base blocks 24 disposed in the bottom of the container 12.

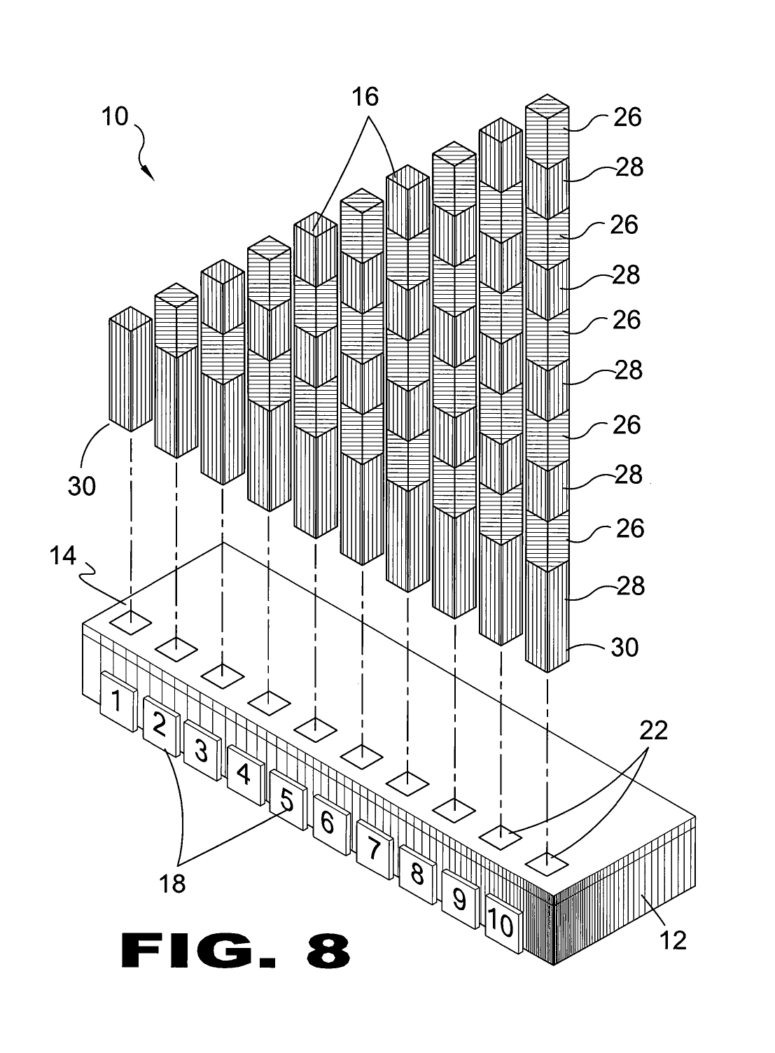

FIG. 8 is an exploded perspective view of the present invention 10. Shown is the mathematical learning device 10 having a container 12 and lid 14 containing ten calibrated rods 16 of lengths to represent place values of numbers that the user stands vertically by inserting the base 30 of the rods 16 into the recesses 22 provided in the lid 14 and base block at the bottom of the container 16. Number tiles 18 are also provided and are placed relevant to the rod 16 placement. The rods 16 are incrementally calibrated into representative numerical units by alternating bands of a first color 26 and a second color 28. The multicolor aspect not only serves to differentiate between numerical increments but aids in gaining and maintaining a child's interest.

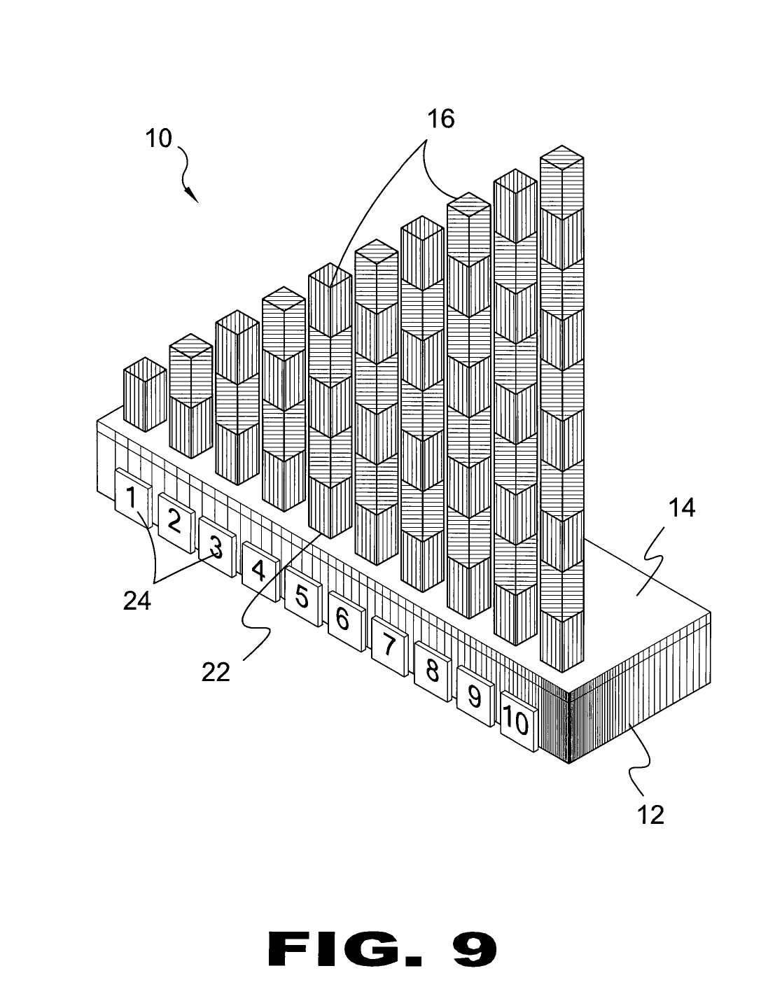

FIG. 9 is a perspective view of the present invention 10. Shown is the lid 14 on the container 12 and the rods 16 positioned within their respective recesses 22 as indicated by the numeric tiles 18.

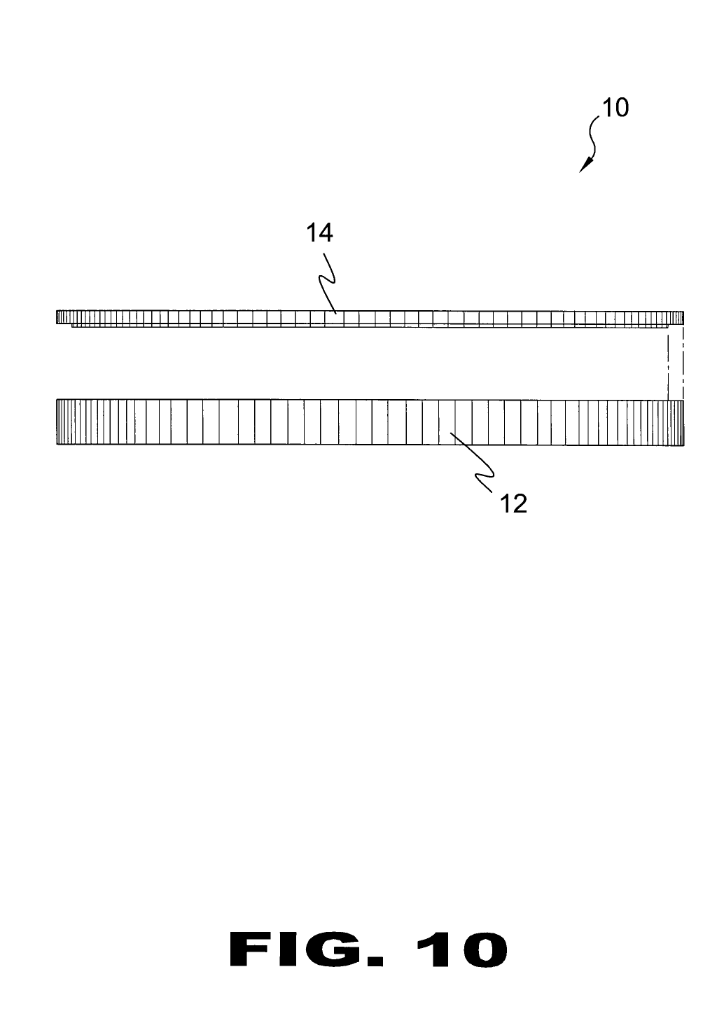

FIG. 10 is a side exploded view of the present invention 10. Shown is the lid 14 removed from the container 12

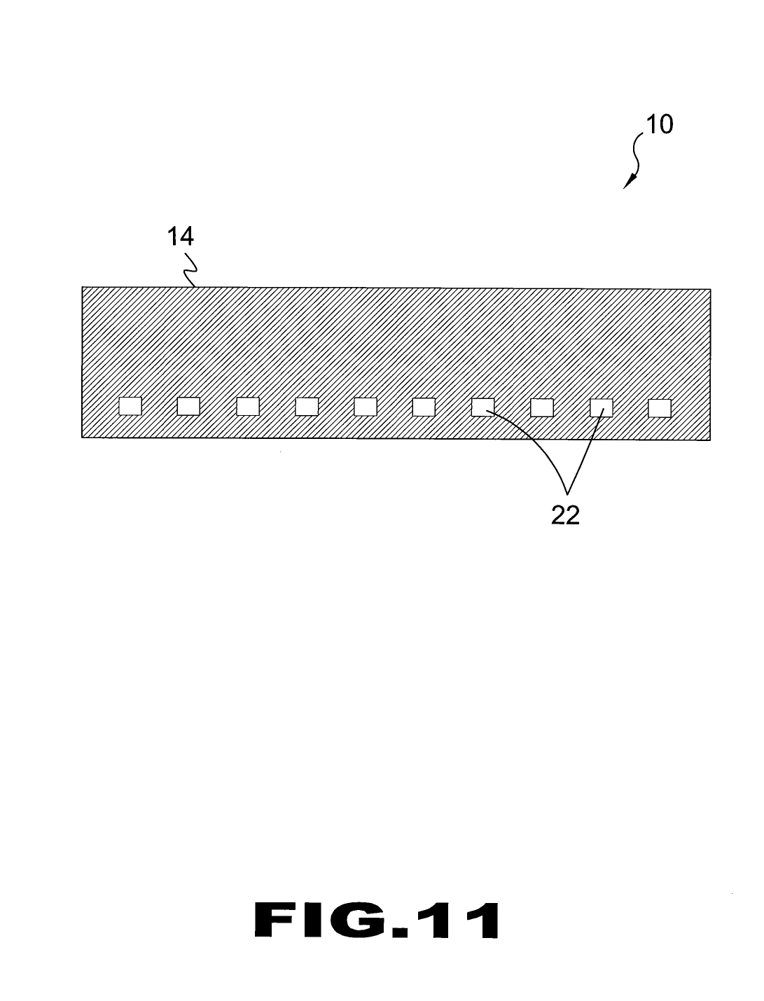

FIG. 11 is a top view of the lid 14 of the present invention 10. The present invention is a mathematical learning device for children 10 having a container and lid 14 containing ten calibrated rods of lengths to represent place values of numbers that the user stands vertically by inserting said rods into the recesses 22 provided in the lid 14 and base block at the bottom of the container. Number tiles are also provided and are placed relevant to the rod placement.

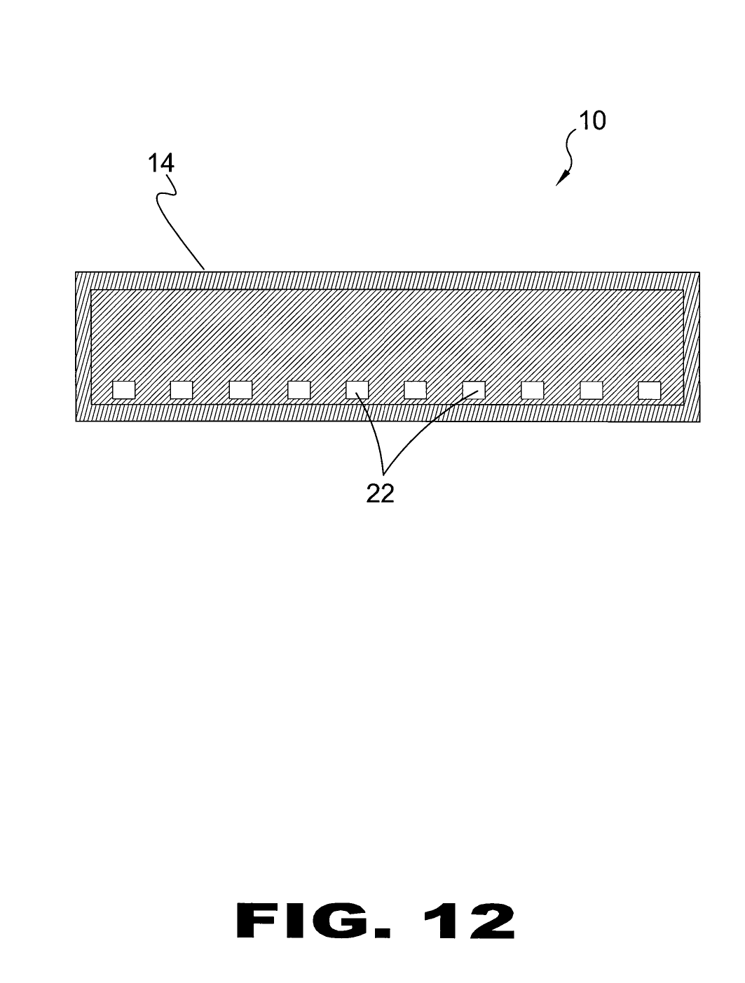

FIG. 12 is a bottom view of the lid of the present invention. The present invention is a mathematical learning device for children 10 having a container and lid 14 containing ten calibrated rods of lengths to represent place values of numbers that the user stands vertically by inserting said rods into the recesses 22 provided in the lid 14 and base block at the bottom of the container. Number tiles are also provided and are placed relevant to the rod placement.

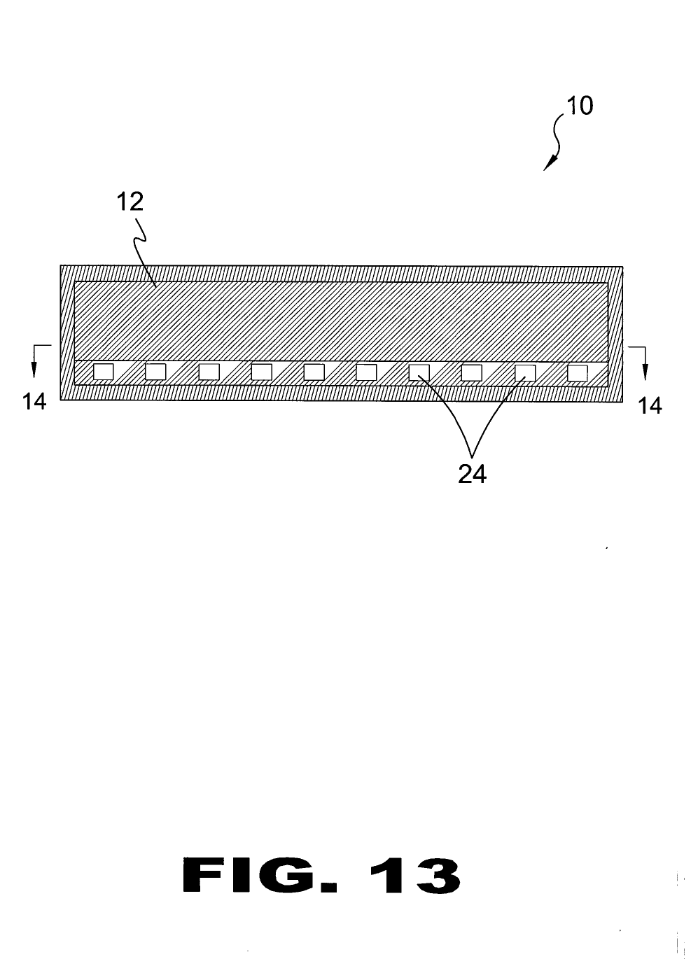

FIG. 13 is a top view of the container 12 of the present invention 10 and its base blocks 24.

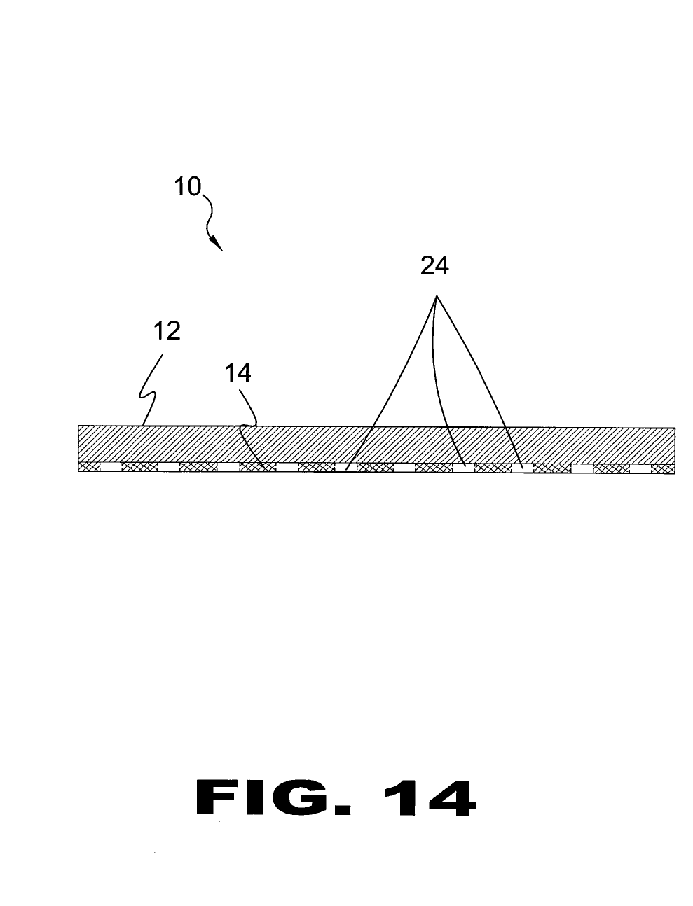

FIG. 14 is a sectional view of the bottom of the container 12 of the present invention 10 and the base blocks 24 at the bottom of the container 12.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A visual mathematical learning aid to teach children numbers and increasing values as they increase from left to right and from bottom to upward direction and in simple addition comprising:
a) a rectangular container;
b) a lid for said container conforming substantially therewith;
c) ten calibrated rods;
each of the ten calibrated rods is of different length;
length difference of any two numerically adjacent calibrated rods of the ten calibrated rods is one length unit;
each of the ten calibrated rods is colored with two different colors;
the ten calibrated rods are measured with one length unit, two, three, four, five, six, seven, eight, nine, and ten length units respectively;
d) ten recesses linearly and longitudinally being displaced in said lid;
each of the ten calibrated rods being inserted through one of the ten recesses;
e) ten tiles having numeric indicia of numeric one to numeric ten respectively;
the ten tiles being disposed on one longitudinal face of the container;
each of the ten tiles being placed in front of and corresponds to one of the ten calibrated rods;
the numeric indicia of each of the ten tiles represents the number of length units of a calibrated rod that the tile corresponds to;
f) ten base grooves being displaced in an internal face of the container;
each of the ten base grooves corresponds to one of the ten recesses; and
each of the ten calibrated rods sits in one of the ten base grooves.

2. (canceled)

3. (canceled)

4. (canceled)

5. (canceled)

6. The visual mathematical learning aid to teach children recited in claim 5, wherein each of said calibrated rods comprises a base portion.

7. (canceled)

8. The visual mathematical learning aid to teach children recited in claim 7, wherein the calibrated rod with one length unit being inserted into the far left recess; and
the calibrated rod with ten length unit being inserted into the right most recess.

9. The visual mathematical learning aid to teach children recited in claim 8, wherein each of the ten calibrated rods being disposed in its respective recess from left to right in ascending order.

10. The visual mathematical learning aid to teach children recited in claim 9, wherein each of said ten calibrated rods increases by one length unit from the adjacent rod to its left.

11. The visual mathematical learning aid to teach children recited in claim 10, wherein the number of length units on each rod are easily distinguishable from one another by every other unit alternately having a band with a first color and the other having a color band with a second color.

12. (canceled)

13. (canceled)

14. (canceled)

15. A method of providing a visual aid that supports numbers have values and they increase from left to right and from bottom to upward direction comprising sequentially following the steps of:
a) removing ten calibrated rods and ten numeric tiles from a base container;
b) placing a lid on top of the container;
c) identifying a shortest rod of the ten calibrated rods and placing in a recess furthest to the left and said rod stands vertically;
d) counting the number of color bands on the rod previously placed;
e) identifying the numeric tile that coincides with the number of bands on said rod;
f) placing said numeric tile adjacent to the rod that coincides with that number of bands;
g) identifying the rod next in length and place in lid recess to the right of previously placed rod; and
h) repeating (steps d-g) until all rods of increasing length are placed into base blocks and coinciding numeric disc is placed adjacent to said rods.

16. A method of providing visual mathematical learning of simple arithmetic comprising sequentially following the step of:
a) removing ten calibrated rods and ten numeric tiles from a base container;
b) placing a lid on top of the container;
c) selecting a pair of the calibrated;
d) counting the sum of units on the selected pair of the calibrated rods;
e) counting the number of bands on both of said calibrated rods; and
f) selecting the tile or tiles resulting in the sum of the equation.
